(19) United States
(12) Patent Application Publication
(10) Pub. No.: US 2025/0028898 A1
(43) Pub. Date: Jan. 23, 2025

(54) INFORMATION PROCESSING METHOD AND APPARATUS, TERMINAL AND STORAGE MEDIUM

(71) Applicant: Beijing Zitiao Network Technology Co., Ltd., Beijing (CN)

(72) Inventors: Zikai QI, Beijing (CN); Yifan DING, Beijing (CN); Kai DU, Beijing (CN); Kuo PEI, Beijing (CN); Ni ZHUANG, Beijing (CN)

(21) Appl. No.: 18/709,453

(22) PCT Filed: Nov. 17, 2022
(86) PCT No.: PCT/CN2022/132617

§ 371 Date: May 10, 2024

(30) Foreign Application Priority Data
Nov. 17, 2021 (CN) 202111362845.1

(51) Int. Cl. G06F 40/194; G06F 3/0483; G06F 40/106; G06F 40/174; G06F 40/177; G06F 40/197

(52) U.S. Cl. CPC G06F 40/194; G06F 3/0483; G06F 40/106; G06F 40/174; G06F 40/177; G06F 40/197

(57) ABSTRACT

The present disclosure provides an information processing method and apparatus, a terminal and a storage medium. The information processing method includes: obtaining a first type document and a second type document of a preset file, and displaying the first type document and the second type document in a first area of a page, wherein the first type document is an electronic version of the preset file, and the second type document is a scanning version of the preset file; and comparing the first type document with the second type document, and displaying a comparison result of blocky content in a second area of the page, wherein the blocky content includes a picture, a table and/or a newly added page.

### CROSS-REFERENCE TO RELATED APPLICATIONS

This application is based on, and claims the priority to Chinese patent application No. 202111362845.1, filed on Nov. 17, 2021, and entitled “Information processing method and apparatus, terminal and storage medium”, which is incorporated herein by reference in its entirety.

### TECHNICAL FIELD

The present disclosure relates to the field of information technology, and in particular to an information processing method and apparatus, a terminal and a storage medium.

### BACKGROUND

In some document comparison methods, usually, comparison differences will be returned after an original document and a comparison document are input. However, the existing comparison methods cannot solve the problems of table recognition, multi-page addition, identity recognition and recognition of other pictures in documents. In addition, the existing comparison methods usually do not support the recognition of block results (for example, tables and pictures), resulting in excessive false positives.

### SUMMARY

To solve the existing problems, the present disclosure provides an information processing method and apparatus, a terminal and a storage medium.

The present disclosure adopts the following technical solution.

An embodiment of the present disclosure provides an information processing method, including: acquiring a first type document and a second type document of a preset file, and displaying the first type document and the second type document in a first area of a page, wherein the first type document is an electronic version of the preset file and the second type document is a scanned version of the preset file; and comparing the first type document with the second type document, and displaying a comparison result of blocky content in a second area of the page, wherein the blocky content includes a picture, a table and/or a newly added page.

Another embodiment of the present disclosure provides an information processing apparatus, wherein the information processing apparatus includes an acquiring module and a comparing module, the acquiring module is configured to acquire a first type document and a second type document of a preset file, and display the first type document and the second type document in a first area of a page, wherein the first type document is an electronic version of the preset file and the second type document is a scanned version of the preset file; and the comparing module is configured to compare the first type document with the second type document, and display a comparison result of blocky content in a second area of the page, wherein the blocky content includes a picture, a table and/or a newly added page.

In some embodiments, the present disclosure provides a terminal including at least one memory and at least one processor, wherein the at least one memory is configured to store a program code, and the at least one processor is configured to invoke the program code stored in the at least one memory to execute the above information processing method.

In some embodiments, the present disclosure provides a storage medium for storing a program code for executing the above information processing method.

An embodiment of the present disclosure can display a comparison result of blocky content in a second area of a page, wherein the blocky content includes pictures, tables and/or newly added pages, so that the problem of comparison between the pictures, tables and/or newly added pages in documents are solved.

### BRIEF DESCRIPTION OF THE DRAWINGS

The above and other features, advantages, and aspects of embodiments of the present disclosure will become more apparent from the following detailed description when taken in conjunction with the accompanying drawings. Throughout the drawings, the same or similar reference numbers refer to the same or similar elements. It should be understood that the drawings are schematic and that components and elements are not necessarily drawn to scale.

FIG. 1 is a flowchart of an information processing method according to an embodiment of the present disclosure.

FIGS. 2 to 6 show schematic diagrams of contents displayed in a first area and a second area of a page according to some embodiments.

FIG. 7 is partial modules for an information processing apparatus according to some embodiments of the present disclosure.

FIG. 8 is a schematic structural diagram of an electronic device according to an embodiment of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure may be embodied in various forms and should not be construed as limited to the embodiments set forth here, but rather, these embodiments are provided for a more thorough and complete understanding of the present disclosure. It should be understood that the drawings and the embodiments of the present disclosure are for illustration purposes only and are not intended to limit the scope of the present disclosure.

It should be understood that the steps described in the method embodiments of the present disclosure may be performed in a different order and/or in parallel. Furthermore, the method embodiments may include additional steps and/or omit performing the illustrated steps. The scope of the present disclosure is not limited in this respect.

As used herein, the term “comprising” and its variants are inclusive, that is, “including but not limited to”. The term “based on” means “at least partially based on”. The term “one embodiment” means “at least one embodiment”; the term “another embodiment” means “at least one other embodiment”; and the term “some embodiments” means “at least some embodiments”. Related definitions of other terms will be given in the following description.

It is noted that the terms “first”, “second”, and the like in the present disclosure are only used for distinguishing different apparatuses, modules or units, and are not used for limiting the order or interdependence of the functions performed by these apparatuses, modules or units.

It is noted that references to “a” or “an” in the present disclosure are intended to be illustrative rather than limiting, and should be understood as “one or more” by those skilled in the art, unless the context clearly indicates otherwise.

The names of messages or information exchanged between apparatuses in the embodiments of the present disclosure are for illustrative purposes only, and are not intended to limit the scope of the messages or information.

The current document comparison does not support the identification of block results, resulting in excessive comparison false positives for documents (e.g., contracts).

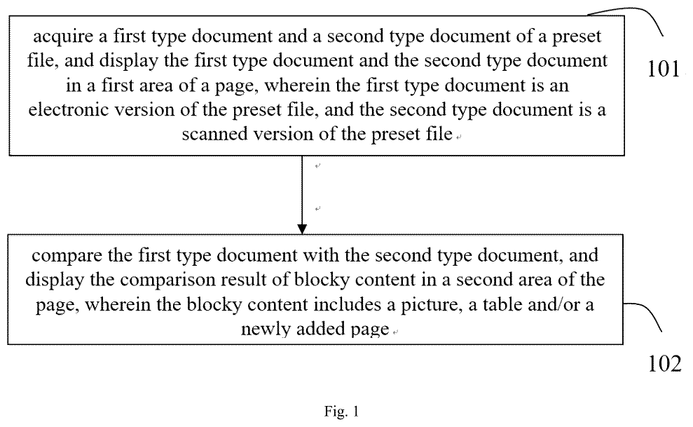

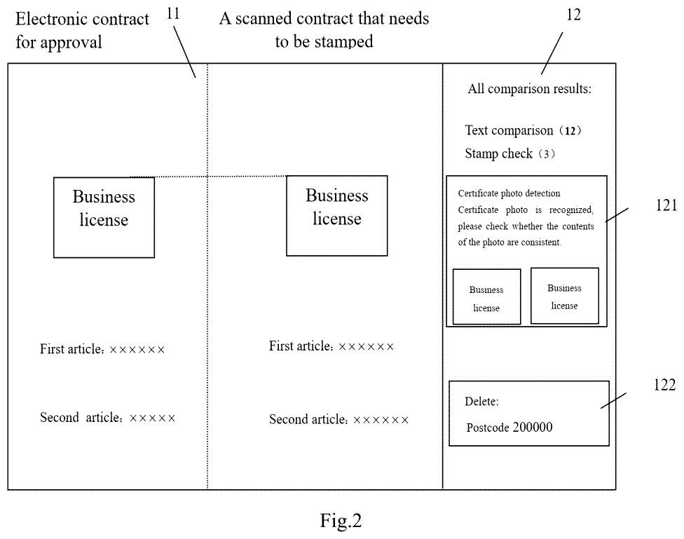

FIG. 1 provides a flowchart of an information processing method according to an embodiment of the present disclosure. The information processing method of the present disclosure may include step 101, acquiring a first type document and a second type document of a preset file, and displaying the first type document and the second type document in a first area of a page. In some embodiments, the preset file may include any suitable file such as contracts, financial statements, etc. In some embodiments, the first type document is an electronic version of the preset file, and the second type document is a scanned version of the preset file. For example, as shown in FIG. 2, a first type document and a second type document are displayed in a first area 11 of a page. The first type document is an electronic contract, and the second type document is a scanned contract that needs to be stamped.

In some embodiments, the method of the present disclosure may further include step 102, comparing the first type document with the second type document, and displaying the comparison result of blocky content in a second area 12 of the page, wherein the blocky content includes a picture, a table and/or a newly added page. FIG. 2 shows an example in which the blocky content is a picture.

An embodiment of the present disclosure can display the comparison result of blocky content in a second area of a page, wherein the blocky content includes pictures, tables and/or newly added pages, so that the problem of comparison between the pictures, tables and/or newly added pages in documents are solved.

In some embodiments, the comparison results are displayed in a card form.

FIG. 2 schematically shows two cards 121 and 122, wherein each card represents one comparison result. With the adoption of a card display mode, the comparison results can be easily distinguished and the confusion of the comparison results is prevented.

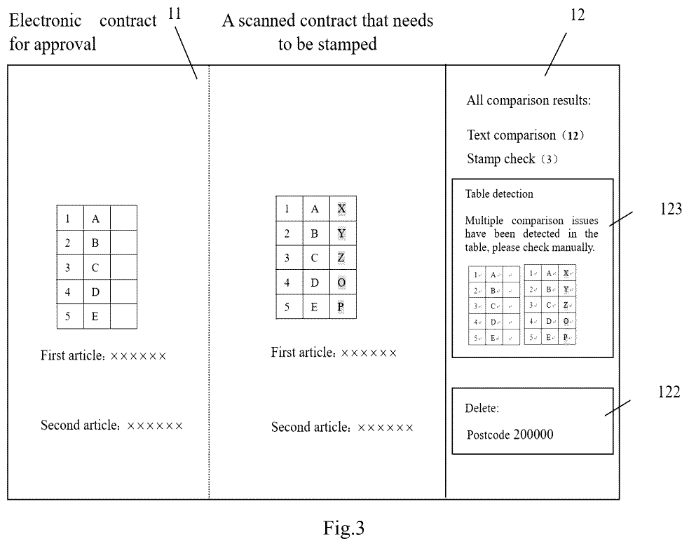

In some embodiments, when the blocky content includes a table and the number of single-line comparison results of the table is greater than a first threshold and/or the number of overall comparison results for the table is greater than a second threshold, the entire content of the table is displayed in the card. In some embodiments, the first threshold may be any suitable value, for example, 1, 2 or 3. In some embodiments, the second threshold may be any suitable value, for example, 5, 6 or 7. For example, as shown in FIG. 3, the number of a single-row comparison result of the table is 1, and the number of overall comparison results of the table is 5, and assuming that the second threshold value is 4, all the content of the table can be displayed in the card 123 for summary processing. In some embodiments, the comparison result of each table is displayed as one card, table spreads (or table across pages) may also be treated as one table, and an excessively long table can be truncated.

In some embodiments, the information processing method of the present disclosure further includes: jumping to the page where the table, the picture or the newly added page is located, and highlighting the table, the picture or the newly added page, in response to a first preset operation for the table, the picture or the newly added page in the first type document, the second type document or the comparison result. In some embodiments, the first preset operation may include a click operation, a voice command, and the like. For example, as shown in FIG. 2, when a comparison result of a business license is clicked, the first type document and the second type document can jump to a page where a picture of the business license is located. In some embodiments, highlighting may include box selection, bold and any suitable way. Similarly, for example, when the pictures of business licenses in the first type document and the second type document are clicked, the comparison result may also jump to a page displaying the comparison result of the business license. In this way, it is convenient for users to check differences and comparison results between documents.

In some embodiments, as described above, in addition to jumping to the page where the table, the picture or the newly added page is located in response to a second preset operation for the table, the picture or the newly added page in the first type document, the second type document or the comparison result, the information processing method of the present disclosure further includes displaying the tables, pictures or newly added pages in the first type document and the second type document in alignment. In some embodiments, the second preset operation may include a click operation, a voice command, and the like. For example, when the picture of the business license in the first type document is clicked, the picture of the business license in the first type document is displayed in alignment with the picture of the business license in the second type document. In some embodiments, the display in alignment may include top alignment, bottom alignment and other suitable ways. In this way, it is convenient to compare tables or pictures.

In some embodiments, in response to a third preset operation for the second area 12, the first type document and the second type document jump to a page corresponding to the comparison result at a preset position of the second area 12. In some embodiments, the third preset operation may include a click operation, a voice command, a slide operation, and the like. In some embodiments, the preset location may be, for example, a middle of the page. For example, when the user slides the second area 12, if the comparison result of the business license is displayed in the middle of the page of the comparison result at this time, the first type document and the second type document jump to the page where the business license is located. In some embodiments, with the sliding of the second area 12, the first type document and the second type document can slide similarly, so as to maintain the consistency of corresponding display content and facilitate the user to check the comparison result.

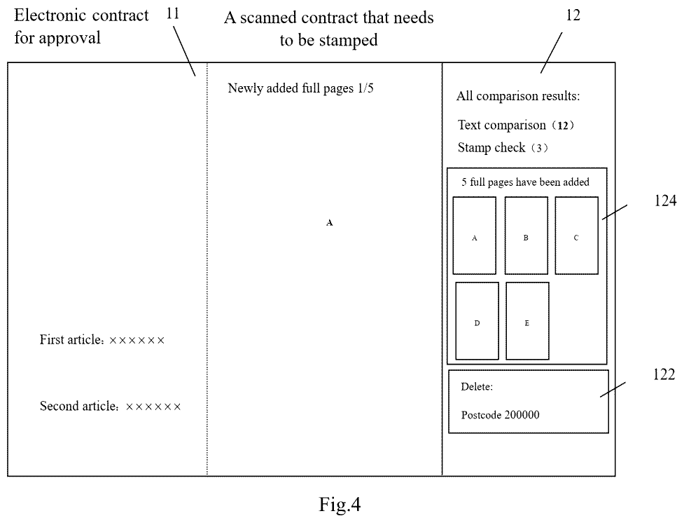

In some embodiments, when a plurality of continuous differences between the second type document and the first type document are all newly added pages, a plurality of continuous newly added pages are merged into one card for display, and the plurality of continuous newly added pages are displayed in the form of thumbnails in the one card. For example, as shown in FIG. 4, the second type document has 5 continuous newly added pages relative to the first type document, and the 5 continuous newly added pages can be displayed in one card 124, and are displayed in the card 124 in the form of thumbnails. In this way, the comparison result of the newly added page is more concise, so that it is convenient for the user to check the comparison result, and the display of the content newly added in the newly added page in the comparison result is omitted. In some embodiments, when a certain page of the continuous newly added pages is clicked, the second type document jumps to the page displaying the newly added page.

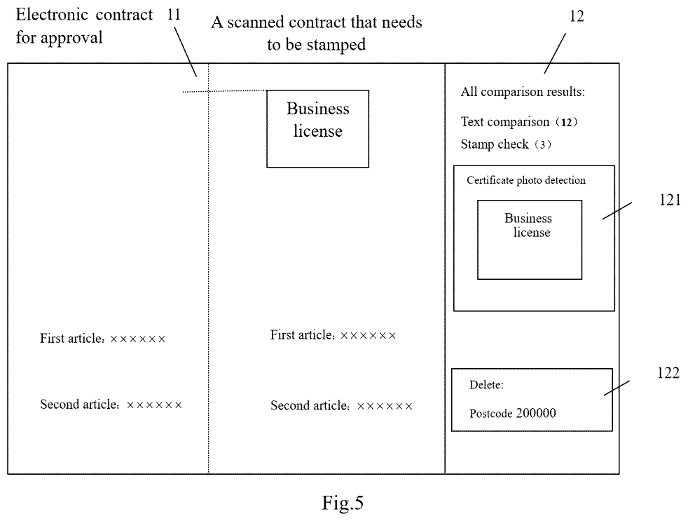

In some embodiments, when the table and/or picture of one of the first type document and the second type document are displayed on a current page, the comparative display is performed based on a top of the table and/or picture and a corresponding line number of the page where the table and/or picture are located. As shown in FIG. 5, in a case that only the second type document has a picture among the first type document and the second type document, the top of the picture can be displayed by comparing with the top of the page (corresponding to the first line of the page), that is, the picture is positioned at the top of the page. It should be understood that this is merely exemplary and the picture can be positioned in any suitable position, for example, in the middle of the page, etc. Similarly, when only one of the first type documents and the second type documents has a table, the table can be displayed by comparing with the corresponding line number of the page, for example, at the top, middle or other suitable position of the page.

In some embodiments, when the table and/or picture of the first type document and the table and/or picture of the second type document are both displayed on the current page, a connection mark is displayed in the first type document and the second type document based on the tops of the corresponding tables and/or pictures. As shown in FIG. 2, when the picture of the business license in the first type document and the picture of the business license in the second type document are both displayed on the current page, a connection mark is displayed in the first type document and the second type document based on the tops of the pictures of the business licenses, as shown by the dotted line at the tops of the pictures of the business licenses in FIG. 2. Similarly, when both the table in the first type document and the table in the second type document are displayed on the current page, a connection mark can be displayed in the first type document and the second type document based on the tops of the corresponding tables, that is, the tops of the tables are aligned. In this way, it is convenient to compare pictures or tables.

In some embodiments, in the comparison results, comparison results of consecutive pictures are returned in the form of separate pictures. For example, for 5 consecutive pictures, 5 cards may be respectively displayed in the comparison results.

In some embodiments, the information processing method of the present disclosure further includes: sending a selected corresponding card to a group chat in response to a preset operation for the card with the comparison result. In some embodiments, the cards in the comparison results can be single-selected or multi-selected, for example, a card selection control may appear after a long press on one of the cards. Thereafter, in response to the triggering of a sending control, the selected card is sent to a preset group chat. In some embodiments, the preset group chat may include any instant messaging application and email (e.g., mass-mailing), etc.

In some embodiments, the information processing method of the present disclosure further includes: automatically sending a preset comparison result and corresponding description information to an instant messaging application. In some embodiments, some key comparison results (e.g., whole newly added pages, tables, etc.) and corresponding description information may be automatically sent to the instant messaging application. That is, if it is set to automatically send the comparison results of tables and whole newly added pages to a certain group, once the whole newly added pages or tables appear in the comparison results, the cards of the comparison results and the corresponding description information will be automatically sent to the group. In some embodiments, the description information of the new comparison results of the whole newly added page may include a number of newly added pages and corresponding paginations. In some embodiments, the description information of the table comparison results may include, for example, “multiple comparison issues are detected in the table, please check manually”.

In some embodiments, when there is a replacement between pictures and characters or a replacement between tables and characters between the first type document and the second type document, the corresponding pictures, tables and characters are highlighted, and replacement description information is displayed in the comparison result. For example, if a picture in a first type document is replaced by characters in a second type document, both the picture in the first type document and the corresponding characters in the second type document are highlighted, for example, the picture is in a box selection state and the corresponding characters are in a highlighted state. Moreover, replacement description information is displayed in the comparison result, for example, “the picture in the first type document is replaced by the following text in the second type document”, and so on. Similarly, if some characters in the first type document are replaced by a picture in the second type document, those characters in the first type document and the corresponding picture in the second type document are also highlighted, and for example, “the following characters in the first type document are replaced by a picture in the second type document” is displayed in the comparison result. Similarly, when there is a replacement between tables and characters between the first type document and the second type document, the corresponding highlighting is performed and the replacement description information is displayed in the comparison result, for example, “the following characters in the first type document are replaced by a table in the second type document”. In this way, it is more convenient to check the differences between documents.

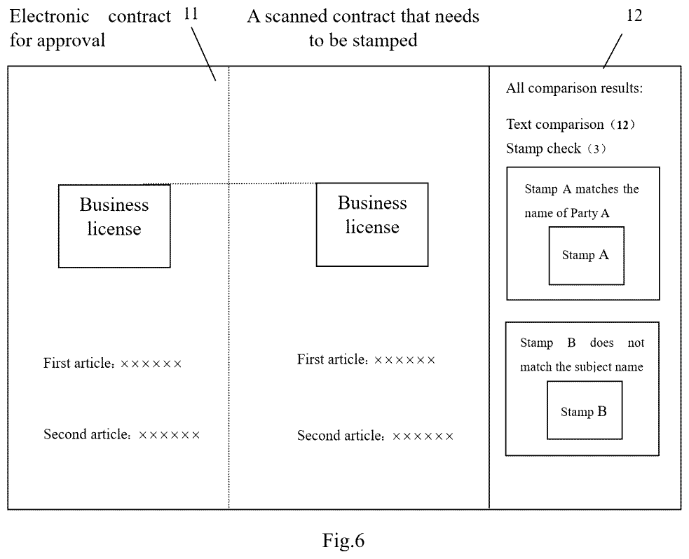

In some embodiments, the comparison result also includes stamp detection information on whether stamps in the first type document and the second type document are matched with a subject. As shown in FIG. 6, a stamp check in the comparison result is schematically shown. In the stamp check in the comparison result, it may show which stamp is matched with a subject name and which stamp is not matched with any subject name. It should be understood that this process may be completed by optical character recognition (OCR) of the name in the stamp and comparison with the subject name (for example, Party A's name and Party B's name) in the document (for example, a contract). In some embodiments, a system may preset which stamps can be matched with corresponding subject names, that is, they don't have to be exactly the same; for example, if Party A is “Da Da Company” and a stamp text is “Special Financial stamp for Da Da Company”, the system can preset that they are matched without just displaying “Da Da Company” in the stamp. Therefore, the information processing method of the present disclosure can be used not only to compare texts, but also to check whether the stamps are matched, thereby checking whether wrong stamps are stamped.

According to the information processing method disclosed by the present disclosure, features of tables, pictures and whole newly added pages are identified, and the corresponding tables, pictures and whole newly added pages can be located. In addition, when there are many differences in the tables, block recognition and box selection prompt are carried out, so that the problems of excessive false positives caused by the tables, pictures and whole newly added pages are effectively solved. In addition, through the linkage or jumping of the display content of the first type document, the second type document and the comparison result, it is convenient for the user to check the differences between the documents.

An embodiment of the present disclosure also provides an information processing apparatus 600. The information processing apparatus 600 includes an acquiring module 601 and a comparing module 602. In some embodiments, the acquiring module 601 is configured to acquire a first type document and a second type document of a preset file, and display the first type document and the second type document in a first area of a page, wherein the first type document is an electronic version of the preset file and the second type document is a scanned version of the preset file. In some embodiments, the comparing module 602 is configured to compare the first type document with the second type document, and display the comparison result of blocky content in the second area of the page, wherein the blocky content includes pictures, tables and/or newly added pages.

It should be understood that the content described about the information processing method is also applicable to the information processing apparatus 600 here, and will not be described in detail here for the sake of simplicity.

In some embodiments, the comparison results are displayed in a card form. In some embodiments, when the blocky content includes a table and the number of single-line comparison results of the table is greater than a first threshold and/or the number of overall comparison results for the table is greater than a second threshold, the entire content of the table is displayed in the card. In some embodiments, the information processing apparatus further includes a control module configured to jump to the page where the table, the picture or the newly added page is located, and highlight the table, the picture or the newly added page, in response to a preset operation for the table, the picture or the newly added page in the first type document, the second type document or the comparison result. In some embodiments, the control module is configured to jump to the page where the table, the picture or the newly added page is located, and display the tables, pictures or newly added pages in the first type document and the second type document in alignment, in response to a preset operation for the table, the picture or the newly added page in the first type document, the second type document or the comparison result. In some embodiments, the control module is further configured to allow the first type document and the second type document to jump to a page corresponding to a comparison result at a preset position of the second area in response to a preset operation for the second area. In some embodiments, the control module is further configured to: when a plurality of continuous differences between the second type document and the first type document are all newly added pages, merge continuous multiple newly added pages into one card for display, and display the continuous multiple newly added pages in the form of thumbnails in one card. In some embodiments, the control module is further configured to perform comparative display based on a top of the table and/or picture and a corresponding line number of the page where the table and/or picture are located when the table and/or picture of one of the first type document and the second type document are displayed on a current page. In some embodiments, the control module is further configured to display a connection mark in the first type document and the second type document based on the tops of the corresponding tables and/or pictures when the table and/or picture of the first type document and the table and/or picture of the second type document are both displayed on the current page. In some embodiments, the comparison results are returned in the form of separate pictures. In some embodiments, the control module is further configured to send a selected corresponding card to a group chat in response to a preset operation for the card with the comparison result. In some embodiments, the control module is further configured to automatically send a preset comparison result and corresponding description information to an instant messaging application. In some embodiments, the control module is further configured to highlight the corresponding pictures, tables and characters when there is a replacement between pictures and characters or a replacement between tables and characters between the first type document and the second type document, and display replacement description information in the comparison result. In some embodiments, the comparison result also includes stamp detection information on whether stamps in the first type document and the second type document are matched with a subject.

In addition, the present disclosure also provides a terminal, including: at least one memory and at least one processor, wherein the memory is used for storing program codes, and the processor is used for invoking the program codes stored in the memory to perform the information processing method.

Moreover, the present disclosure also provides a computer storage medium storing a program code for executing the above information processing method.

The information processing method and apparatus of the present disclosure have been described above based on the embodiments and application examples. In addition, the present disclosure also provides a terminal and a storage medium, which are described below.

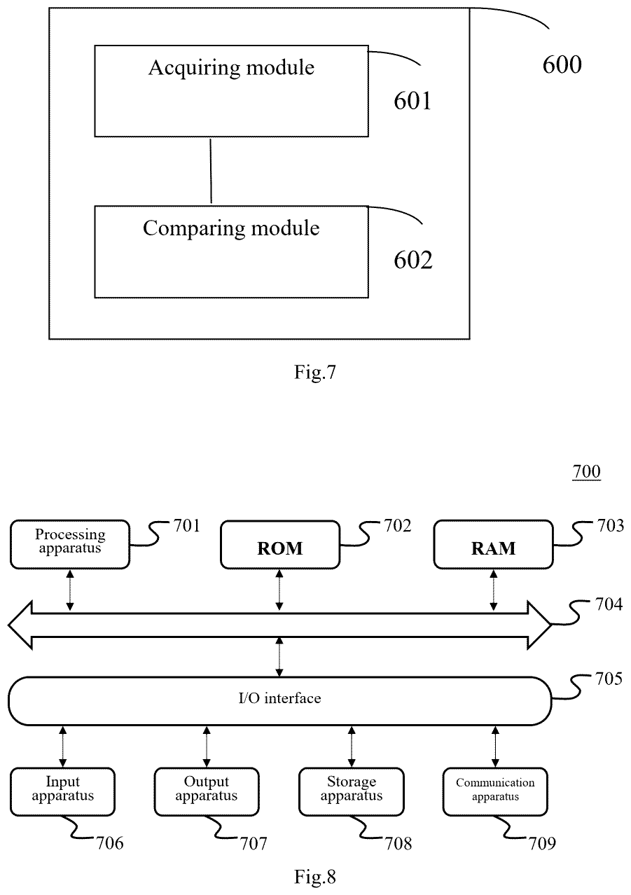

Reference is now made to FIG. 7, which shows a structural schematic diagram of an electronic device (for example, a terminal device or a server) 700 suitable for implementing an embodiment of the present disclosure. The terminal devices in the embodiments of the present disclosure may include, but not limited to, mobile terminals such as a mobile phone, a notebook computer, a digital broadcast receiver, a personal digital assistant (PDA), a tablet computer (PAD), a portable multimedia player (PMP), a vehicle-mounted terminal (for example, a vehicle-mounted navigation terminal) and the like, and fixed terminals such as a digital TV, a desktop computer and the like. The electronic device shown in FIG. 7 is only an example, and should not bring any limitation to the functions and application scope of the embodiments of the present disclosure.

As shown in FIG. 7, the electronic device 700 may include a processing apparatus (for example, a central processing unit, a graphics processing unit) 701, which may perform various appropriate actions and processes according to programs stored in a read-only memory (ROM) 702 or programs loaded from a storage apparatus 708 into a random access memory (RAM) 703. In the RAM 703, various programs and data required for operations of the electronic device 700 are also stored. The processing apparatus 701, the ROM 702 and the RAM 703 are connected to each other through a bus 704. An input/output (I/O) interface 705 is also connected to the bus 704.

Generally, the following apparatuses may be connected to the I/O interface 705: an input apparatus 706 including, for example, a touch screen, a touch pad, a keyboard, a mouse, a camera, a microphone, an accelerometer, a gyroscope, etc.; an output apparatus 707 including, for example, a liquid crystal display (LCD), a speaker, a vibrator, etc.; a storage apparatus 708 including, for example, a magnetic tape, a hard disk, etc.; and a communication apparatus 709. The communication apparatus 709 may allow the electronic device 700 to perform wireless or wired communication with other devices to exchange data. While the electronic device 700 with various apparatuses is shown in the FIG. 7, it should be understood that it is not required to implement or have all the apparatuses shown. More or fewer apparatuses may alternatively be implemented or provided.

In particular, according to the embodiments of the present disclosure, processes described above with reference to the flowchart may be implemented as a computer software program. For example, an embodiment of the present disclosure includes a computer program product, which includes a computer program carried on a computer-readable medium, the computer program including program codes for performing the method shown in the flowchart. In such an embodiment, the computer program may be downloaded and installed from a network through the communication apparatus 709, or installed from the storage apparatus 708, or installed from the ROM 702. When the computer program is executed by the processing apparatus 701, the above functions defined in the method of the embodiment of the present disclosure are performed.

It should be noted that the computer-readable medium mentioned above in the present disclosure may be a computer-readable signal medium or a computer-readable storage medium or any combination of both. The computer-readable storage medium may be, for example, but not limited to, an electrical, magnetic, optical, electromagnetic, infrared, or semiconductor system, apparatus or device, or a combination of any of the above. More specific examples of the computer-readable storage medium may include, but not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium containing or storing a program, which program may be used by or in combination with an instruction execution system, apparatus or device. In the present disclosure, the computer-readable signal medium may include a data signal propagated in a baseband or as part of a carrier wave, in which computer-readable program codes are carried. This propagated data signal may take multiple forms, including but not limited to electromagnetic signals, optical signals or any suitable combination of the above. The computer-readable signal medium may also be any computer-readable medium other than the computer-readable storage medium, and may send, propagate or transmit a program used by or in combination with an instruction execution system, apparatus or device. The program codes contained in the computer-readable medium may be transmitted by any suitable medium, including but not limited to: electric wires, optical cables, radio frequency (RF) and the like, or any suitable combination of the above.

In some embodiments, a client and the server can communicate by using any currently known or future developed network protocol such as a hypertext transfer protocol (HTTP), and may be interconnected with digital data communication in any form or medium (for example, a communication network). Examples of the communication network include a local area network (“LAN”), a wide area network (“WAN”), the Internet work (for example, the Internet) and an end-to-end network (for example, an ad hoc end-to-end network), as well as any currently known or future developed networks.

The computer-readable medium described above may be included in the electronic device; or it may exist alone without being assembled into the electronic device.

The computer-readable medium described above carries one or more programs, which, when executed by the electronic device, cause the electronic device to perform the method of the present disclosure.

Computer program codes for performing the operations of the present disclosure may be written in one or more programming languages or combinations thereof, including object-oriented programming languages such as Java, Smalltalk and C++, and conventional procedural programming languages such as “C” or similar programming languages. The program codes may be completely executed on a user computer, partially executed on the user computer, executed as an independent software package, partially executed on the user computer and partially executed on a remote computer, or completely executed on the remote computer or a server. In the case involving the remote computer, the remote computer may be connected to the user computer through any type of network, including a local area network (LAN) or a wide area network (WAN), or may be connected to an external computer (for example, through the Internet using an Internet service provider).

The flowchart and block diagrams in the drawings illustrate architectures, functions and operations of possible implementations of the systems, methods and the computer program product according to various embodiments of the present disclosure. In this regard, each block in the flowchart or block diagram may represent a part of a module, a program segment, or codes, which includes one or more executable instructions for implementing specified logical functions. It is also noted that, in some alternative implementations, the functions noted in the block may occur out of the order noted in the figures. For example, two blocks shown in succession may, in fact, be executed substantially in parallel, and may sometimes be executed in the reverse order, depending on the functions involved. It is also noted that each block in the block diagrams and/or flowcharts, and combinations of blocks in the block diagrams and/or flow diagrams, may be implemented by a dedicated hardware-based system that performs specified functions or operations, or by a combination of dedicated hardware and computer instructions.

The units involved in the embodiments described in the present disclosure may be implemented by software or hardware. The name of the unit does not constitute a limitation on the unit itself in some cases.

The functions described above herein may be at least partially performed by one or more hardware logic components. For example, without limitation, exemplary types of hardware logic components that may be used include: a field programmable gate array (FPGA), an application-specific integrated circuit (ASIC), an application specific standard product (ASSP), a system-on-chip (SOC), a complex programmable logic device (CPLD) and the like.

In the context of the present disclosure, the machine-readable medium may be a tangible medium that may include or store a program used by or in connection with an instruction execution system, apparatus or device. The machine-readable medium may be a machine-readable signal medium or a machine-readable storage medium. The machine-readable medium may include, but not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a convenient compact disk read-only memory (CD-ROM), an optical storage device, a magnetic storage device, or any suitable combination of the above.

One or more embodiments of the present disclosure provide an information processing method, including: acquiring a first type document and a second type document of a preset file, and displaying the first type document and the second type document in a first area of a page, wherein the first type document is an electronic version of the preset file and the second type document is a scanned version of the preset file; and comparing the first type document with the second type document, and displaying a comparison result of blocky content in a second area of the page, wherein the blocky content includes a picture, a table and/or a newly added page.

In one or more embodiments of the present disclosure, the comparison result is displayed in a card form.

In one or more embodiments of the present disclosure, when the blocky content includes the table and a number of single-line comparison results of the table is greater than a first threshold and/or the number of overall comparison results for the table is greater than a second threshold, all content of the table is displayed in a card.

In one or more embodiments of the present disclosure, the information processing method further including: jumping to a page where the table, the picture or the newly added page is located, and highlighting the table, the picture or the newly added page, in response to a preset operation for the table, the picture or the newly added page in the first type document, the second type document or the comparison result.

In one or more embodiments of the present disclosure, the information processing method further including: jumping to the page where the table, the picture or the newly added page is located, and displaying the table, the picture or the newly added page in the first type document and the second type document in alignment, in response to a preset operation for the table, the picture or the newly added page in the first type document, the second type document or the comparison result.

In one or more embodiments of the present disclosure, in response to a preset operation for the second area, the first type document and the second type document jump to a page corresponding to a comparison result at a preset position of the second area.

In one or more embodiments of the present disclosure, when a plurality of continuous differences between the second type document and the first type document are all newly added pages, a plurality of continuous newly added pages are merged into one card for display, and the plurality of continuous newly added pages are displayed in the form of thumbnails in the one card.

In one or more embodiments of the present disclosure, when a table and/or a picture of one of the first type document and the second type document are displayed on a current page, the comparative display is performed based on a top of the table and/or the picture and a corresponding line number of the page where the table and/or picture are located.

In one or more embodiments of the present disclosure, when the table and/or picture of the first type document and the table and/or picture of the second type document are both displayed on the current page, a connection mark is displayed in the first type document and the second type document based on the tops of the corresponding tables and/or pictures.

In one or more embodiments of the present disclosure, the comparison result is returned in the form of separate pictures.

In one or more embodiments of the present disclosure, the information processing method further including: sending a selected corresponding card to a group chat in response to a preset operation for a card of the comparison result.

In one or more embodiments of the present disclosure, the information processing method further including: automatically sending a preset comparison result and corresponding description information to an instant messaging application.

In one or more embodiments of the present disclosure, when there is a replacement between pictures and characters or a replacement between tables and characters between the first type document and the second type document, the corresponding pictures, tables and characters are highlighted, and replacement description information is displayed in the comparison result.

In one or more embodiments of the present disclosure, the comparison result further includes stamp detection information on whether stamps in the first type document and the second type document are matched with a subject.

One or more embodiments of the present disclosure provide an information processing apparatus, wherein the information processing apparatus includes an acquiring module and a comparing module, the acquiring module is configured to acquire a first type document and a second type document of a preset file, and display the first type document and the second type document in a first area of a page, wherein the first type document is an electronic version of the preset file and the second type document is a scanned version of the preset file; and the comparing module is configured to compare the first type document with the second type document, and display a comparison result of blocky content in a second area of the page, wherein the blocky content includes a picture, a table and/or a newly added page.

One or more embodiments of the present disclosure provide a terminal including at least one memory and at least one processor, wherein the at least one memory is configured to store program codes, and the at least one processor is configured to invoke the program codes stored in the at least one memory to execute the information processing method described in any of the above embodiments.

One or more embodiments of the present disclosure provide a storage medium for storing a program code for executing the information processing method described in any of the above embodiments.

The foregoing description is only exemplary of the preferred embodiments of the present disclosure and is illustrative of the principles of the technology employed. It will be appreciated by those skilled in the art that the scope of the present disclosure herein is not limited to the particular combination of technical features described above, but also encompasses other combinations of features described above or equivalents thereof without departing from the spirit of the present disclosure. For example, the above features are replaced with (but not limited to) technical features with similar functions disclosed in the present disclosure.

Moreover, although the operations are depicted in a particular order, this should not be understood as requiring that these operations be performed in the particular order shown or in a sequential order. Under certain circumstances, multitasking and parallel processing may be beneficial. Likewise, while several specific implementation details are included in the above discussion, these should not be construed as limitations on the scope of the present disclosure. Some features described in the context of separate embodiments can also be combined in a single embodiment. On the contrary, various features that are described in the context of a single embodiment can also be implemented in multiple embodiments separately or in any suitable subcombination.

Although the subject matter has been described in language specific to structural features and/or methodological acts, it is to be understood that the subject matter defined in the appended claims is not necessarily limited to the specific features or acts described above. On the contrary, the specific features and acts described above are merely exemplary forms of implementing the claims.

1. An information processing method, comprising:
acquiring a first type document and a second type document of a preset file, and displaying the first type document and the second type document in a first area of a page, wherein the first type document is an electronic version of the preset file and the second type document is a scanned version of the preset file; and
comparing the first type document with the second type document, and displaying a comparison result of blocky content in a second area of the page, wherein the blocky content comprises a picture, a table and/or a newly added page.

2. The information processing method according to claim 1, wherein the comparison result is displayed in a card form.

3. The information processing method according to claim 1, wherein when the blocky content comprises the table and a number of single-line comparison results of the table is greater than a first threshold and/or a number of overall comparison results for the table is greater than a second threshold, all content of the table is displayed in a card.

4. The information processing method according to claim 1, further comprising:
jumping to a page where the table, the picture or the newly added page is located, and highlighting the table, the picture or the newly added page, in response to a preset operation for the table, the picture or the newly added page in the first type document, the second type document or the comparison result.

5. The information processing method according to claim 1, further comprising:
jumping to a page where the table, the picture or the newly added page is located, and displaying the table, the picture or the newly added page in the first type document and the second type document in alignment, in response to a preset operation for the table, the picture or the newly added page in the first type document, the second type document or the comparison result.

6. The information processing method according to claim 1, wherein in response to a preset operation for the second area, the first type document and the second type document jump to a page corresponding to a comparison result at a preset position of the second area.

7. The information processing method according to claim 2, wherein when a plurality of continuous differences between the second type document and the first type document are all newly added pages, a plurality of continuous newly added pages are merged into one card for display, and the plurality of continuous newly added pages are displayed in a form of thumbnails in the one card.

8. The information processing method according to claim 1, wherein when a table and/or a picture of one of the first type document and the second type document are displayed on a current page, a comparative display is performed based on a top of the table and/or the picture and a corresponding line number of a page where the table and/or the picture are located.

9. The information processing method according to claim 1, wherein when a table and/or a picture of the first type document and a table and/or a picture of the second type document are both displayed on a current page, a connection mark is displayed in the first type document and the second type document based on tops of corresponding tables and/or pictures.

10. The information processing method according to claim 2, wherein the comparison result is returned in a form of separate pictures.

11. The information processing method according to claim 2, further comprising: sending a selected corresponding card to a group chat in response to a preset operation for a card of the comparison result.

12. The information processing method according to claim 1, further comprising: automatically sending a preset comparison result and a corresponding description information to an instant messaging application.

13. The information processing method according to claim 1, wherein when a replacement between a picture and characters or a replacement between a table and characters exists between the first type document and the second type document, a corresponding picture, a corresponding table and corresponding characters are highlighted, and replacement description information is displayed in the comparison result.

14. The information processing method according to claim 1, wherein the comparison result further comprises stamp detection information on whether stamps in the first type document and the second type document are matched with a subject.

15. An information processing apparatus, wherein the information processing apparatus comprises:
an acquiring module configured to acquire a first type document and a second type document of a preset file, and display the first type document and the second type document in a first area of a page, wherein the first type document is an electronic version of the preset file and the second type document is a scanned version of the preset file; and
a comparing module configured to compare the first type document with the second type document, and display a comparison result of blocky content in a second area of the page, wherein the blocky content comprises a picture, a table and/or a newly added page.

16. A terminal, comprising:
at least one memory and at least one processor,
wherein the at least one memory is configured to store a program code, and the at least one processor is configured to invoke the program code stored in the at least one memory to;
acquire a first type document and a second type document of a preset file, and display the first type document and the second type document in a first area of a page, wherein the first type document is an electronic version of the preset file and the second type document is a scanned version of the preset file; and
compare the first type document with the second type document, and display a comparison result of blocky content in a second area of the page, wherein the blocky content comprises a picture, a table and/or a newly added page.

17. A storage medium for storing a program code for executing the information processing method according to claim 1.

18. The information processing apparatus according to claim 15, wherein the comparison result is displayed in a card form.

19. The information processing apparatus according to claim 15, wherein when the blocky content comprises the table and a number of single-line comparison results of the table is greater than a first threshold and/or a number of overall comparison results for the table is greater than a second threshold, all content of the table is displayed in a card.

20. The terminal according to claim 16, wherein the comparison result is displayed in card form.
